(19) United States
(12) Patent Application Publication
(10) Pub. No.: US 2007/0263114 A1
(43) Pub. Date: Nov. 15, 2007

(54) Ultra-thin digital imaging device of high resolution for mobile electronic devices and method of imaging

(75) Inventors: Igor Gurevich, Saarbrucken (DE); Victor Faybishenko, San Carlos, CA (US); Leonid Velikov, San Carlos, CA (US)

Correspondence Address: Leonid Velikov, 1371 Greenbrier Road, San Carlos, CA, 94070, US

(73) Assignee: Microalign Technologies, Inc.

(21) Appl. No.: 11/413,788

(22) Filed: May 1, 2006

(51) Int. Cl. H04N 5/225

(52) U.S. Cl. 348/340

(57) ABSTRACT

An ultra-thin digital imaging device has a thickness of several millimeters and is capable of producing data for creating images of 3 Mp and higher. The device comprises a multi-channel imaging unit that contains a plurality of optical channels formed by microlens objectives and a pixilated image sensor unit with a plurality of sensing elements. Each individual identical image obtained through each optical channel is pixilated and converted into electrical signals that are processed into data sets which can be stored in the imaging device and either reproduced on the display of the device or transmitted to an external image-reproducing device where the obtained data of individual images are transformed into a single, high-resolution megapixel image by means of a technique known in the art.

### FIELD OF THE INVENTION

The invention relates to a digital image-sensing and image-reproducing device, in particular to aforementioned device for producing high-resolution megapixel images of remote objects and having dimensions in the direction of the optical axis of the device in the range of several millimeters. The digital imaging unit of the invention is most suitable for integration into devices that have limitations with regard to weight and overall dimensions, such as portable cameras and mobile electronic devices, e.g., iPods, Palm computers, smart phones, and other small form-factor mobile electronic devices and computers, miniature photo-cameras, on-board vision systems of military machines, surveillance cameras, etc.

### BACKGROUND OF THE INVENTION

Imaging system technique is one of rapidly growing fields of industry, and the image-sensing, image-reproducing, image-reconstructing techniques find ever growing application in practice. It is worth mentioning that in the field of photography, alone, digital cameras are constantly improved and modernized from year to year and become less expensive in production and more advances in their performance characteristics. Each new generation of digital photo cameras brings radically improved image quality.

It is also necessary to mention digital machine vision systems that find rapidly growing use in production and processing equipment, military machines, vehicles, etc. In these fields, the digital vision systems show manifold growth.

Very popular nowadays are easily affordable home and office security systems that are based on use of digital image sensors combined into networks. Such networks survey a certain space, and often have to be placed in hidden locations or into locations with limited space. In view of the above, one of main trends in the field of digital imaging systems is their miniaturization in combination with improvement of performance characteristics.

There exist a great variety of image sensing system and devices that are aimed at improving image quality in combination with decreases in the overall dimensions of the systems or devices.

For example, Published US Patent Applications No. 2005/0128509 and No. 2005/0160112 (applicant Timo Tokkonen, et al) describe digital imaging devices and methods that are based on the use a two- or four-channel optical system that creates images on the surface of a pixilated sensor. The pixilated image-sensing surface of the sensor is divided into two or four fields. When two fields are used, one field is associated with two colors, i.e., red and blue, while the second field is associated with a monochromatic green color. When four fields, each field is associated with a predetermined color, i.e., red, blue, and green. The fourth field may be used for obtaining a so-called meta image. According to the inventions of the aforementioned patent publications, a real image is obtained by interposing the monochromatic images of each field onto each other in an image-displaying device.

However, the devices and methods of the aforementioned patent publications are aimed at improved organization of image color transfer and do not essentially improve image resolution. Another disadvantage is that the aforementioned devices and systems require the use of a specific arrangement of color pixilation of the arrayed sensors (CMOS/CCD).

U.S. Patent Application Publication No. 2005/0128335 (applicant Timo Kolehmainen) discloses an imaging device based on the use of a four-channel optical system that creates images on the surface of a pixilated sensor. The pixilated image-sensing surface of the sensor is divided into four fields. Each field is associated with an individual miniature objective lens that has characteristics different from those of other channels. For example, one channel may reproduce a wide-angle image; another channel may be used for reproducing a normal-angle image, etc.

It is understood that in the last-mentioned system miniaturization is achieved at the expense of image resolution. This occurs because only one-fourth of the pixilated image sensor surface is used for creating images reproduced on the display. In other words, only one-fourth of the sensor resolution capacity is used.

In some cases miniaturization of a digital image reproducing device may be critical for the value of the device. An example of this is a mobile telephone with a built-in camera. Such a camera cannot have large dimensions since the camera should not go exceed the outlines of the mobile phone. Therefore the cameras built into mobile phones have very poor image resolution. A camera would have large overall dimensions to achieve high resolution images. An example of an attempt to improve resolution in a mobile phone camera is a Samsung SCH-V770 camera-phone that is characterized by a 7 megapixel (MP) image sensor. With the use of conventional optics, this device practically converts a mobile phone into a conventional digital camera with a mobile phone, since the camera has the same three-dimensional geometry and size as any digital camera. It is understood that the use of this device as a phone is inconvenient.

Let us also consider compact digital cameras of high resolution (5 to 8 MP). Examples of such cameras are Olympus Stylus 710 (7.1 MP) and Sony Cyber-Shot-T9 (6.0 MP). Both these cameras fall into a category of “thin” cameras that have a thickness of about 20 mm and utilize complex zoom objectives. For example, the objective of the Olympus Stylus 710 (7.1 MP) consists of six lenses, of which four are aspherical lenses. The objective has the Seamless to 15× (combined 3× optical and 5× digital) zoom. The objective creates an image of a remote object on a 7.1 MP 1/2.3 (1.10 cm) CCD. It is understood, that in some modes of image capture, only a part of the total CCD matrix is used. However, in any working position, the front lens of the zoomed objective projects forward from the front face of the camera body, whereby the operational dimensions of the camera, in fact, considerably exceed 20 mm. This feature makes such devices inapplicable for incorporation into a mobile phone.

References to the above-described integration of digital image reproduction devices into mobile phones are given only as examples. It is understood that such incorporation is possible also with compact electronic devices other than telephones, such as small form-factor mobile computers, pocket personal computers, such as Palm personal computers, iPods, iPAKs, smart phones, etc. However, in all examples mentioned above, the weight and dimensions of existing high-resolution devices based on the use of conventional optics will conflict with the aforementioned incorporation.

The reasons for which the existing high-resolution cameras cannot be made thin enough for incorporation into mobile phones are following. Let us consider, e.g., a high-resolution CCD/CMOS sensor of compact pixilation. The size of the pixel which is minimal nowadays is about 2×2 μm². Such a small area has to accommodate four elementary color microsensors for two green colors, one red color, and one blue color. Such a sensor with a 10 mm side (the diagonal 14 mm) will contain 10 to 12 MP. In order to create an image on a surface area with the characteristic dimension of 14 mm (in our case, the sensor diagonal), it is necessary to use a conventional lens objective with dimensions at least no less than the length of the diagonal. In other words, the minimal length of such an optical system in the optical-axis direction should be no less than the diameter of the objective. Furthermore, the higher the resolution, the greater the aforementioned dimension. In other words, in the above example, the high-resolution optical system which is based on the use of conventional objectives cannot be shorter than 14 mm. In reality, this dimension is much larger.

Therefore, in its fundamental principles, conventional optics does not allow creation of a relatively large image of high resolution with optics having a length in the optical axis direction of about several centimeters.

### SUMMARY OF THE INVENION

It is an object of the present invention to provide an ultra-thin and miniature digital imaging system and a method that reproduce an image of a remote object with the same quality of resolution as that of conventional megapixel photocameras. It is another object to provide an ultra-thin digital imaging camera for mobile phones that is capable of producing images comparable in quality of resolution with that of conventional digital camera photography. It is another object to provide an ultra-thin high-resolution (e.g., higher than 3 MP) digital imaging device having a dimension in the direction of the optical axis (thickness) in the order of several millimeters. It is an object of the invention to provide a digital imaging device having a dimension in the direction of the optical axis several times smaller than the dimension in the direction perpendicular to the optical axis. It is another object of the invention to provide a digital imaging device that allows compact integration with small-factor computers, Palm personal computers, iPods, smart phones, etc. It is another object is to provide a method for improving resolution of a pixilated image obtained with the use of a pixilated image sensor.

The device of the invention comprises: a multi-channel imaging unit that contains a plurality of optical channels, each in the form of a miniature objective, e.g., a microlens objective; and a pixilated image sensor unit with a plurality of sensing elements. The number of sensing elements is greater than the number of optical channels. Image-receiving surfaces of the sensing elements are located in the image plane of the multi-channel imaging unit so that a plurality of individual identical images of the remote object is reproduced on the aforementioned sensing elements. The device contains a memory or storage unit that can store a plurality of data sets that corresponds to the plurality of individual identical images of the remote object. The device also contains an output port for transmitting data sets stored in the storage unit to the external memory device. Furthermore, the device is equipped with a display and a digital image processor linked with the aforementioned storage for processing one data set for image reproduction on the above display. Moreover, there is an inner port for connecting the storage unit with cellular phone circuitry for wireless transmission of the aforementioned plurality of data sets to another external memory. The optical system of the invention may have a thickness of several millimeters. This is achieved because the above thickness is defined only by the thickness of the components of the multiple-channel lens-array system designed on an entirely new principle.

### BRIEF DESCRIPTION OF THE DRAWINGS

FIG. 1A is an exploded schematic three-dimensional view of a digital imaging device according to the invention.

FIG. 1B is a three-dimensional front view of a smart phone integrated with a digital imaging device of the invention.

FIG. 1C is a three-dimensional back-side view of the smart phone of FIG. 1B.

FIG. 2 is a general three-dimensional view of the multi-channel imaging unit contained in the device of the invention.

FIG. 3 is a sectional view along the line III-III of FIG. 2.

FIG. 4 is a schematic view that shows geometrical parameters of the multi-channel imaging unit and tracing of the rays passing through this unit.

FIG. 5 illustrates another embodiment of the multi-channel imaging unit where lenses are made as separate optical elements that are inserted into respective holders.

FIG. 6 is a block diagram that shows the structure of the digital signal processing of data for creating an image of the object on the display of the device of the invention and for transmitting the data to the external data processing device.

### DETAILED DESCRIPTION OF THE INVENTION

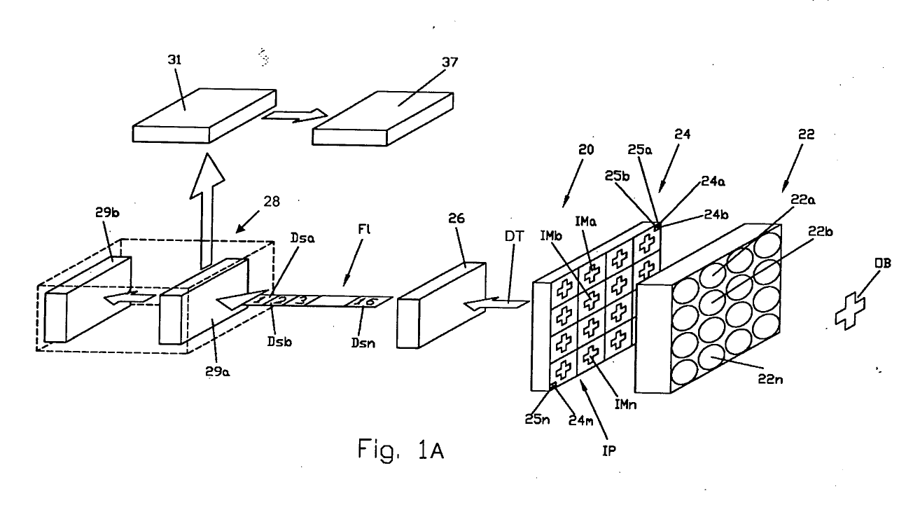

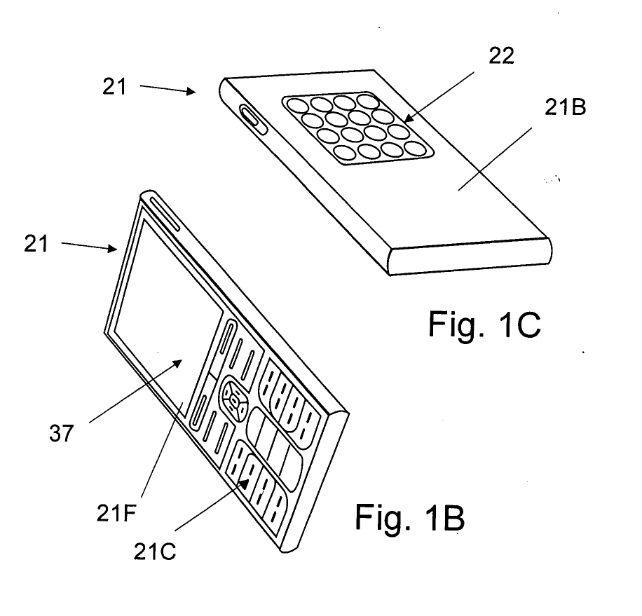

Structure of the System of the Invention (FIGS. 1-6)

The ultra-thin digital imaging device of the invention (hereinafter referred to as device) is shown schematically in the attached drawings, where FIG. 1A is an exploded schematic three-dimensional view of the device, which, as a whole, is designated by reference numeral 20.

In the context of the present patent specification the term “ultra-thin” means that the thickness of a digital imaging device does not exceed 50% of the diagonal of the image-receiving surface in an image-receiving unit such as CCD/CMOS.

The device 20 comprises: a multi-channel imaging unit 22 that contains a plurality of optical channels 22a, 22b, . . . 22n, each in the form of a miniature objective, e.g., a microlens objective and a pixilated image sensor unit 24 with a plurality of sensing elements 24a, 24b, . . . 24m (only three of such sensing elements are shown and designated in FIG. 1A). The number “m” of the sensing elements 24a, 24b, . . . 24m is significantly greater, e.g., by 10⁴ to 10⁶ times greater, than the number “n” of the optical channels. Image-receiving surfaces 25a, 25b, . . . 25n of the sensing elements 24a, 24b, . . . 24m are located in the image plane IP of the multi-channel imaging unit 22, so that a plurality of individual identical images IMa, IMb, . . . IMn of the remote object OB is reproduced on the aforementioned sensing elements 24a, 24b, . . . 24m.

As can be seen from FIG. 1A, the device 20 also contains a digital signal processor 26 and a data storage 28. The digital signal processor 26 receives data from the pixilated image sensor unit 24 for converting the data into a plurality, e.g., sixteen, substantially identical data sets DSa, DSb, . . . to DSn (in the illustrated example n=16), which correspond to respective individual images IMa, IMb, . . . IMn (i.e., IM16). The digital signal processor 26 converts the aforementioned data sets as a sequential data train into a data set file FL that can be transmitted directly or after conversion, e.g., compression, to a data storage unit 28. The data storage unit contains a memory unit 29a and an output port 29b that can be used for transmitting the store data sets DSa, DSb, . . . DSn to an external device, e.g., to a personal computer [not shown] for processing the data sets and reproducing them as an image of the remote object OB, or through the telephone. Furthermore, the device 20 also contains a built-in digital signal processor 31, which is connected to a display 37 of the device 20. For example, if the device is a smart phone equipped with a miniature digital photo camera, the display 37 is the small display screen normally provided on such phones. An example of a smart phone that incorporates a digital imaging device 20 is shown in FIG. 1B and FIG. 1C, where FIG. 1B is a three-dimensional front view of a smart phone 21 integrated with a digital imaging device of the invention, and FIG. 1C is a three-dimensional back-side view of the smart phone of FIG. 1B. In these drawings, reference numeral 21B designates the back side of the smart phone 21, and 22 designates an extremely thin optical assembly that may have a thickness of about several millimeters and therefore can be built into the body of the smart phone 21 without extending beyond the contours of the phone body. For example, the external surface of the optical assembly 22 may be coplanar with the surface of the back side 21B.

Functional features of the smart phone 21 are shown in FIG. 1B, where reference numeral 21F designates the front-side surface of the smart phone 21, 21C designates a control panel with buttons, or the like, and 37 designates a display.

Since the device shown in FIG. 1A consists of the extremely thin optical assembly 22, the thin pixilated image sensor unit 24, and miniature memory units, processors, etc., the thickness of the entire device will not exceed several millimeters, which makes such a device unique among devices of this type. Another unique feature of the device of the invention is that the digital data sets FL stored in the memory unit 29a can be transmitted to an external device, e.g., a personal computer, and can be converted into an image of the remote object, the picture of which is captured by the imaging device 20 that corresponds in its quality and resolution to the image obtained from a high-end digital camera with pixilation of 5 to 8 megapixels, or higher.

Since each data set of the stored data sets DSa, DSb, . . . DSn, in fact, represents a single image of “n” substantially identical images IMa, IMb, . . . , IMn, the aforementioned images may be considered as “n” shifted images of the same remote object OB captured by “n” microlenses (16 in the illustrated embodiments).

The term “shifted images” means that the images of the same remote object are captured by the microlens objective of different optical channels at different aspect angles. This occurs because these channels do not coincide but are arranged parallel to each other and are shifted in the transverse direction. It is understood that the aforementioned optical channels will generate individual images that are slightly shifted relative to their central optical axes. Therefore such individual images are herein called “substantially identical”.

Algorithms for converting such sets of shifted images into a single image of higher resolution are known in the art and are used, e.g., for computationally enhancing the resolution of videos by applying a super-resolution reconstruction algorithms (see “Video Super-Resolution Using Controlled Subpixel Detector Shifts” by Moshe Ben-Ezra, et al. in IEEE Transactions on Pattern Analysis and Machine Intelligence, Vol. 27, No. 6, June 2005, pp. 977-987). Other examples of algorithms suitable for the aforementioned conversion are considered in “Kernel Methods for Images” (Learning in Computer Vision II, Lecture No. 13) by M. O. Franz, Jan. 31, 2006. [See http://www2.tuebingen.mpg.de/agbs/lcvii/wiki/lect13.pdf on the Internet].

Having described the device and its units in general, let us consider each unit separately in more detail.

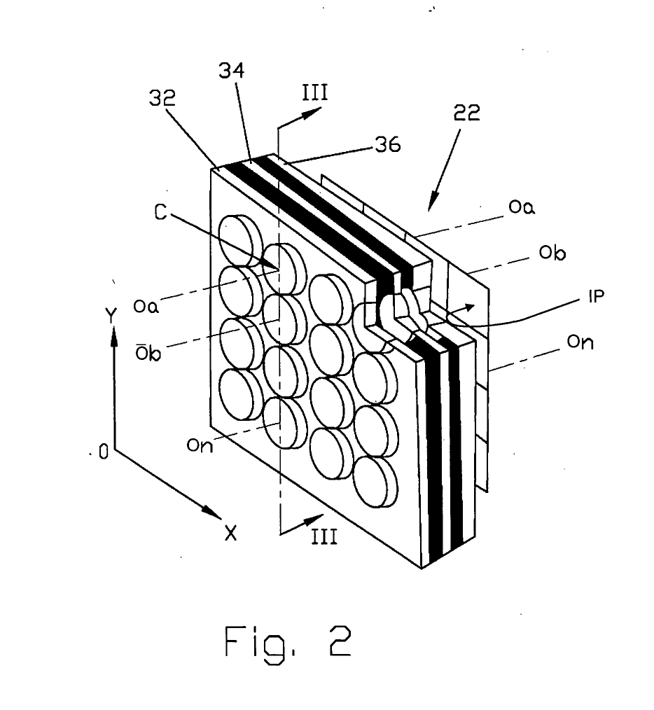

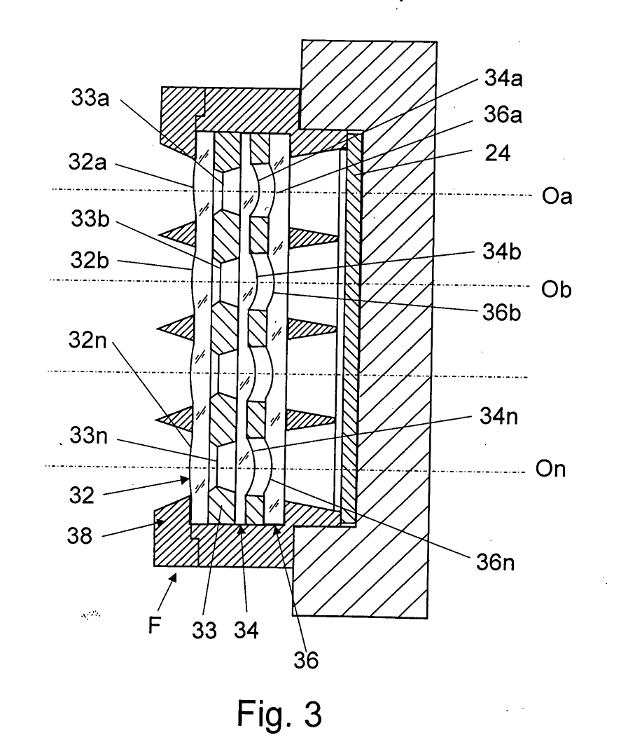

One embodiment of a multi-channel imaging unit 22 is shown in FIG. 2 as a general three-dimensional view of the unit in an assembled state. In FIG. 2, the right upper corner of the multi-channel imaging unit 22 is cut out in order to show the internal layered structure of the unit. The unit 22 has a laminated structure composed of several, e.g., three layers, i.e., a microlens array layers 32, 34, and 36. Each microlens array forms a rectangular lens matrix with the same number of microlenses and the pitch between the microlenses so that the respective microlenses of all three microlens arrays 32, 34, and 36 are coaxial, and each coaxial group of microlenses forms a microlens system. This is shown in FIG. 3, which is a sectional view along the line III-III of FIG. 2. Although in FIG. 3 the multi-channel imaging unit 22 is shown inserted into a supporting frame F and assembled with the pixilated image sensor unit 24, in FIG. 2 the images of the supporting frame F and multi-channel imaging unit 22 are not shown for the sake of simplicity of the drawing.

More specifically, the microlens array 32 contains microlenses 32a, 32b, . . . 32n (16 lenses in the illustrated embodiment). The microlens array 34 contains microlenses 34a, 34b, . . . 34n, which are coaxial with respective microlenses 32a, 32b, . . . 32n of the microlens array 32, and the microlens array 36 contains microlenses 36a, 36b, . . . 36n which are coaxial with respective microlenses of two other arrays. Thus, the coaxial microlenses 32a, 34a, and 36a form a microlens channel 22a shown by axis Oa, and the coaxial microlenses 32b, 34b, and 36b form a microlens channel 22b shown by axis Ob, etc. The multi-channel imaging unit 22 of the embodiment shown in FIGS. 2 and 3 contains in total 16 microlens channels.

Reference numeral 33 designates a spacer having a diaphragm array having diaphragms 33a, 33b, . . . 33n which are coaxial to the respective microlenses 32a, 32b, . . . 32n.

The three microlenses of each microlens channel form an optical system that is capable of forming an individual non-distorted image. For example, the microlenses 32a, 34a, and 36a may create an individual image IMa; the microlenses 32b, 34b, and 36b may create an individual image IMb; and the microlenses 32n, 34n, and 36n may create an individual image IMn (see FIG. 1A).

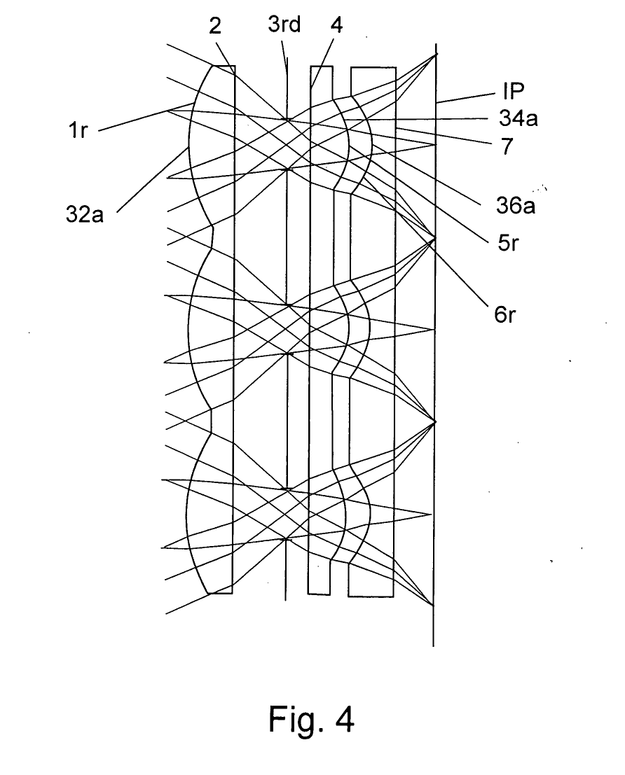

Characteristics of lenses that may form microlens channels shown as axes Oa, Ob . . . On are given in Table 1 and geometrical parameters and ray tracing are shown in FIG. 4. It is understood that these characteristics relate to a channel composed of microlenses given only as examples and that the microlens channels can be formed from a great variety of microlenses of different types, provided that these microlenses satisfy system requirements.

TABLE 1

| | | | Clear | | |
|---|---|---|---|---|---|
| | | | Aperture | | |
| | Lens | | Individual | | |
| | Radii | LensThickness | Channel | Refractive | |
| N | (mm) | (mm) | (mm) | Index | Dispersion |
| 1r | 2.8630* | 1.000 | 3.50 | 1.587 | 29.9 |
| 2 | 0.0000 | 1.050 | 3.00 | | |
| 3 rd | 0.0000 | 0.550 | 1.10 | | |
| 4 | 0.0000 | 0.800 | 2.00 | 1.587 | 29.9 |
| 5r | −1.2720* | 0.500 | 2.00 | | |
| 6r | −0.9465* | 0.870 | 2.90 | 1.587 | 29.9 |
| 7 | 0.0000 | | 2.90 | | |
| Image | | | | | |

The data in Table 1 were calculated for microlens arrays and lenses made from optical polycarbonate with characteristics shown in last two columns of the table. In Table 1, N designates the surface number, where “1r” is the outer surface of the aspherical lens 32a (FIGS. 1 and 3), the value of K for this lens is −2.00; “2” designates the flat back side of the microlens array 32; “3rd” designates the diaphragm 33a; “4” designates a front flat surface of the microlens array 34; “5r” designates the curvilinear aspheric surface of the microlens 34a, the value of K for this microlens is −2.63; “6r” designates the concave aspherical surface of the microlens 36a, this lens has the value of K equal to −2.83; and “7” designates a flat rear surface of the microlens array 36. In FIG. 4, IP is an image plane.

The aforementioned system has the following general characteristics: f′/D ratio is equal to 2.8, where f′ is a focal length of the multi-channel imaging unit 22 and is equal to 4.26 and where f_{b} (working distance) is 0.87; FOV (field of view) is 50°.

All microlenses of the microlens arrays 32, 34, and 36 have pitch Px=2.0 mm in the X-axis direction, and pitch Py=1.50 mm in the Y-axis direction. The axes X and Y are shown in FIG. 2.

The system has the following general characteristics: f′/D ratio=2.8; f′=4.26; f_{b} working distance)=0.87, FOV=50°.

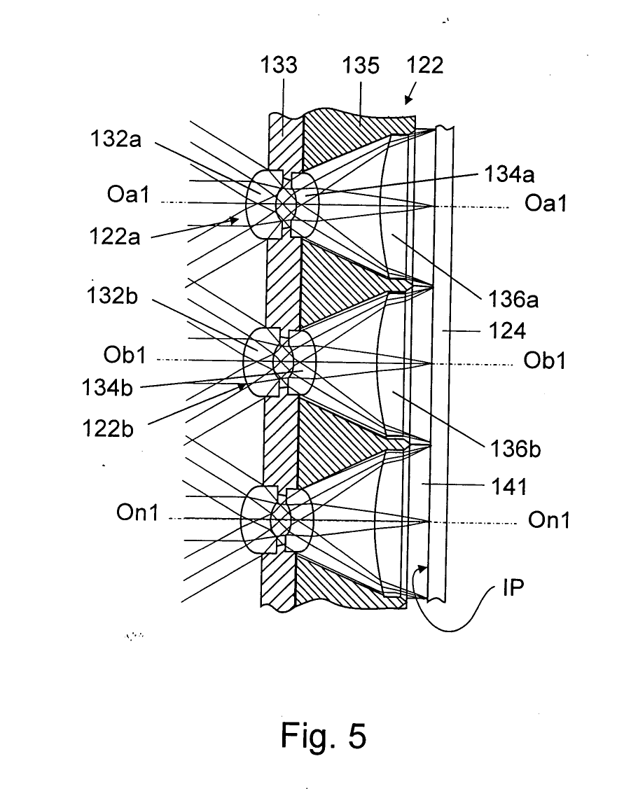

FIG. 5 illustrates another embodiment of a multi-channel imaging unit 122, which optically is the same as the multi-channel imaging unit 22 and differs from the latter by having a different construction. In the embodiment of FIGS. 1 to 4, the multi-channel imaging unit 22 was assembled from monolithic microlens arrays 32, 34, and 36, where all microlenses were formed in monolithic plates, while in the embodiment of FIG. 5, the miniature lenses, e.g., lenses 132a, 134a, and 136a that form a single optical channel 122a are made as separate optical elements that are inserted into respective holders 133 and 135. It is understood that, if necessary, the lenses 136a, 136b, . . . may be formed in a monolithic plate as the microlenses 36a, 36b, . . . .

The embodiment of FIG. 5 makes it possible to create an image sensor suitable for use in conjunction with a digital photo camera where for a standard CMOS sensor with the diagonal dimension of 12 mm the thickness of the CMOS sensor of the invention will be in the order of 6 mm. The existing CMOS sensor of such dimensions allows an image of about 7 MP.

Characteristics of lenses of the optical system shown in FIG. 5 that may form microlens channels shown as axes Oa1, Ob1 . . . On1 are given in Table 2, and geometrical parameters and ray tracing are shown in FIG. 5. It is understood that these characteristics relate to a channel composed of microlenses given only as examples and that the microlens channels can be formed from a great variety of microlenses of different types, provided that these microlenses satisfy system requirements.

TABLE 2

| | | | Clear | | |
|---|---|---|---|---|---|
| | | | Aperture | | |
| | | | Individual | | |
| | | Thickness | Channel | Refractive | |
| N | Radii (mm) | (mm) | (mm) | Index | Dispersion |
| 1r | 1.3420* | 0.935 | 2.20 | 1.587 | 29.9 |
| 2r | 1.2290* | 0.255 | 1.20 | | |
| 3rd | 0.0000 | 0.300 | 1.00 | | |
| 4r | −2.2830* | 0.800 | 1.40 | 1.587 | 29.9 |
| 5r | −1.2370* | 1.800 | 2.00 | | |
| 6r | 5.7040* | 0.800 | 4.20 | 1.587 | 29.9 |
| 7 | 0.0000 | 0.100 | 4.40 | | |
| 8 | 0.0000 | 0.500 | 4.60 | 1.5168 | 64.17 |
| 9 | 0.0000 | 0.250 | 4.60 | | |

The data in Table 2 were calculated for lenses made from optical polycarbonate with characteristics shown in the last two columns of the table. In Table 2, N designates the surface number, where “1r” is the outer surface of the aspherical lens 132a (FIG. 5), the value of K for the surface 1r is 0.60; the value of K for the surface 2r is 3.00, value of K for the surface 4r is 6.60, the value of K for the surface 5r is 0.50 and value of K for the surface 6r is −22.8. “3rd” designates the diaphragm 133a; “4r” designates a front curvilinear surface of the lens 134a; “5r” designates the rear curvilinear aspheric surface of the lens 134a; “6r” designates the concave aspherical surface of the lens 136a; and “7” designates a flat rear surface of the lens 136a. In FIG. 5, IP1 is an image plane. In Table 2, “8” designates the front surface of a flat matching layer 141 that is applied onto the CMOS sensor 124, and “9” is the rear surface of a flat matching layer 141. It is understood that the rear surface “9” of the layer 141 coincides with the image plane IP.

Although the above characteristics were given only for one exemplary channel, it is understood that the same characteristics belong to other channels of the multiple-channel system of the imaging unit shown in FIG. 5.

The aforementioned system had the following general characteristics: f′ (focal length) was equal to 3.5 mm, and FOV (field of view) was 60°; F/2.8.

The lenses were made from optical polycarbonate the characteristics of which are shown in the last two columns of Table 2. The lenses 136a, 136b, . . . 136n were made from BK7 glass of Schott Glass Company (NY, USA) Surface 1r was formed by microcells packed in an orthogonal lattice with pitches Px, equal to 3.6 mm, and Py equal to 2.70 mm. Similarly, surfaces 5r and 6r were formed by microcells packed in an orthogonal lattice with the same pitches (Px, Py).

The next unit in the direction of signal flow after the image sensor unit 24 is the digital signal processor 26 (FIG. 1C) which, in fact, functions as a signal format converter for converting a sequence of signals obtained from the image sensor unit 24 into a formal FL acceptable by the data storage unit 28.

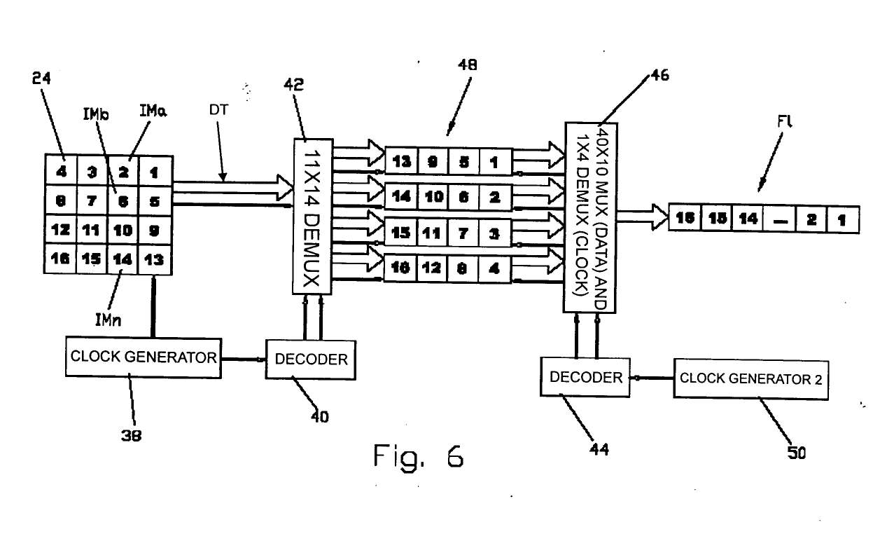

The structure of the digital signal processor 26 is shown in FIG. 6. This drawing also shows a pixilated image sensor unit 24 (FIG. 1A) with sixteen fields for the formation of images IMa, IMb, . . . IMn created by the individual optical channels 22a, 22b, . . . 22n. In FIG. 6, the fields on the surface of the pixilated image sensor unit 24 are designated by numbers “1” to “16”. The purposes of the digital signal processor is to convert electrical signals obtained from the pixels 25a, 25b, . . . 25m (FIG. 1C) into sixteen substantially similar signal-sequence data sets Dsa, Dsb, . . . Dsn (FIG. 6).

More specifically, let us assume that the pixilated image sensor unit 24 is a rectangular matrix that has “m” pixels where m=K×P. Here, K is the number of pixels in the Y-axis direction, and P is the number of pixels in the X-axis direction. According to the design of the optical system 22 shown in the drawings (FIG. 1A to FIG. 6), the system reproduced sixteen substantially similar and equally spaced images IMa, IMb, . . . IMn, where n=16. Each field contains a number of pixels equal to k×p=m/n. It is understood that the following relationships can be written for the system of the illustrated embodiment: k=K/4 and p=P/4. Assume also that the pixilated image sensor unit 24 embeds a 10-bit analog/digital converter (not shown) and has one 10-bit port output. Once the sensor has captured sixteen images, the images must be read, converted to digital signals and stored. Suppose that the pixilated image sensor unit 24 is a known progressive-scan sensor CMOS (hereinafter referred to as “CMOS sensor 24”) where rows are processed one after another in sequence.

The digital signal processor 26 contains a clock generator 38 that is connected to the CMOS sensor 24 and also is connected via a decoder 40 to an 11×44 demultiplexer 42, both contained in the digital signal processor 26. Furthermore, the digital signal processor 26 is equipped with a second decoder 44 and an associated 40×10 multiplexer 46. Reference numeral 48 designates the so-called massive of “fill-in/fill-out files” (hereinafter referred to as FIFO1, FIFO2 . . . FIFOn) that are transmitted from the demultiplexer 42 to the multiplexer 46. In FIG. 6, FIFO1, FIFO2 . . . FIFOn are shown as number “1”, “2”, . . . “16” in the square cells inside the massive 48.

The clock generator 38 is intended for sending clock signals to the CMOS sensor 24 and to the decoder 40, whereby the data train shown by the arrow DT in FIG. 1A, e.g., the data from the images formed in the fields “1” to “16” on the surface of the SMOS sensor 24 begins to flow from the CMOS 24 to the demultiplexer 42. For example, with the start of the clock generator 38, the data from the image IMa and the clock-out signal CK-OUT flow through the demultiplexer 42 to the corresponding FIFO1. The clock-out signal CK-OUT, which is a signal at the output of the sensor 24, goes synchronously with the input clock signal CK-IN (FIG. 6). After the first m/n pulses, the decoder 40 switches the demultiplexer 42, and with the generation of the next clock-out signal the data from the image IMb starts to fill the FIFO2, etc.

Repetition of 4×k pulses fills the FIFO1 with the image IMa, the FIFO2 with the image IMb, . . . FIFOn with the image IMn, respectively. In accordance with this procedure, in the system of the illustrated embodiment, the FIFO1 will be filled with image codes corresponding to fields “1”, “5”, “9”, and “13” of the CMOS sensor 24, the FIFO2 will be filled with the image codes corresponding to fields “2”, “6”, “10”, “14” of the CMOS sensor 24, etc. (see FIG. 6).

Readout of the image codes from the FIFO1, FIFO2, . . . etc. is performed in a similar manner with the use of a clock generator 50, which may be different from the clock generator 38, via the decoder 44. At the end of the conversion process we obtain a stream of data sets Dsa, Dsb, . . . Dsn going sequentially from the digital signal processor 26 to the data storage unit 28 (FIG. 1A).

Operation of the System of the Invention (FIGS. 1-6)

The ultra-thin digital imaging device 20 of the invention operates as described below.

A user captures a picture of the remote object OB (FIG. 1A) in a conventional manner by using the ultra-thin digital camera or digital photo unit of a smart phone (FIGS. 1B and 1C), or the like, which is equipped with the system 20 of the invention. During this process, the multi-channel imaging unit 22 that contains a plurality of optical channels 22a, 22b, . . . 22n, and a pixilated image sensor unit 24 with a plurality of sensing elements 24a, 24b, . . . 24m produces “n” individual and substantially identical images IMa, IMb, . . . IMn of the remote object OB (sixteen images in the illustrated embodiments) on the image-receiving surfaces 25a, 25b, . . . 25n of the sensing elements 24a, 24b, . . . 24m (where “m” is the total number of pixels in all fields located in the IP plane, and m/n is the number of pixels on each field.

The output signals of the pixels are transmitted to the digital signal processor 26 (FIG. 1A) and to the data storage 28. The digital signal processor 26 converts the signal into a plurality (n), e.g., sixteen, substantially identical data sets DSa, DSb, . . . to DSn (in the illustrated example n=16), which correspond to respective individual images IMa, IMb, . . . IMn (i.e., IM16). The digital signal processor 26 converts the aforementioned data sets as a sequential data train into a data set file FL which is transmitted directly or after conversion, e.g., compression, to a data storage unit 28. The data storage unit 28 memorizes the received data sets DSa, DSb, . . . DSn in the memory unit 29a.

When it is necessary to reproduce the picture of the object OB, e.g., to print it out on an external device, e.g., a printer of a personal computer, the aforementioned data sets DSa, DSb, . . . DSn are transmitted from the output port 29b (FIG. 1A) directly to the personal computer (not shown) or wirelessly from the memory unit 29a. An example of wireless transmission is transmission of the data sets from the smart phone (FIGS. 1B and 1C) into which the system 20 is built.

One data set of the aforementioned data sets DSa, DSb, . . . DSn, e.g., DSa, is transmitted from the memory unit 29a to the built-in digital signal processor 31, which is connected to a display 37 of the device 20. If the device is a mobile phone equipped with a miniature digital photo camera, the image can be reproduced on the phone display 37.

Algorithms for converting the aforementioned sets of shifted images into a single image of higher resolution are known in the art (see references mentioned above) and in the commercially available programs (the simplest of which is a program based on PhotoShop). The reproduction of the image on the external data processing device is beyond the scope of the present invention.

In the case of the embodiment shown in FIG. 5, the operation of the system 20 is the same, except that built-in lenses 132a, 132b, 132n, 134a, 134b, . . . 134n, and 136a, 136b, . . . 136n are used for reproduction of individual images IMa, IMb, . . . IMn instead of microlenses 32a, 32b, 32n, 34a, 134b, . . . 34n, and 36a, 36b, . . . 36n of the microlens arrays 32, 34, and 36, respectively.

Thus, it has been shown that the invention provides an ultra-thin and miniature digital imaging system that reproduces an image of a remote object with the same resolution quality as that of conventional medium and high-resolution megapixel photo cameras. The aforementioned optical system may be built into mobile phones or other mobile electronic devices of the types mentioned above and is capable of producing images comparable in quality of resolution with that of conventional high-resolution digital camera photography. The system is suitable for obtaining high-resolution (e.g., higher than 3 MP) digital images with a photo camera having a dimension in the direction of the optical axis (thickness) in the order of several millimeters, i.e., a dimension in the direction of the optical axis several times smaller than the dimension in the direction perpendicular to the optical axis. The invention also provides a method for improving resolution of a pixilated image obtained with the use of a pixilated image sensor. Since the lenses of the system of the invention have short focal length, the images produced by such lenses will always have a high depth of focus.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the number “n” of image fields may be different from 16, and the number of pixels “m” may vary in a wide range. Microlens arrays, microlenses, and insertable lenses can be made from different optical materials, and the characteristics given in Table 1 and Table 2 will be respectively changed to match the dimensions and materials of the lenses. The optical system of the invention may be built not only into mobile phones but into other miniature devices, such as business cards, small thin calculators, covers of pocket telephone books, or as separate slim digital photo cameras having a thickness of several millimeters. The thin camera may be attached to a vehicle or placed into a hidden location for security purposes and for operation with predetermined periodicity or for switching on/off from a remote control device. The principles of the invention are applicable not only to high-resolution imaging devices operating in the range of visible-light wavelengths but also to devices operating in the range of infrared and UV wavelengths.

1. An ultra-thin digital imaging device comprising:
a multi-channel imaging unit that contains a plurality of optical channels formed by a plurality of lens objectives having a common image plane for reproducing a plurality of substantially identical individual shifted images produced by said plurality of optical channels. said ultra-thin digital imaging device having a thickness;
a pixilated imaging sensor unit having a pixilated image-receiving surface that has a diagonal and coincides with said common image plane and that is formed by a plurality of microsensors capable of converting said individual shifted images projected onto said common image plane into electrical signals;
a first data processing unit connected to said pixilated imaging sensor for receiving said electrical signals and for converting said electrical signals into data sets; and
a data storage unit for receiving said data sets from said data processing unit and for storing said data sets.

2. The ultra-thin digital imaging device of claim 1, further comprising
at least one data output port connected to said data storage unit for transmitting said data sets to an external device.

3. The ultra-thin digital imaging device of claim 1, which comprises a photo camera built into a mobile electronic device.

4. The ultra-thin digital imaging device of claim 3, further comprising a second digital data processor and a display unit connected to said second data processor.

5. The ultra-thin digital imaging device of claim 3, further comprising
at least one data output port connected to said data storage unit for transmitting said data sets to an external device.

6. The ultra-thin digital imaging device of claim 3, further comprising means for wire transmission of said data sets from said data storage unit to an external device.

7. The ultra-thin digital imaging device of claim 1, wherein said multi-channel imaging unit comprises at least one lens array of identical lenses formed monolithically from a single piece of an optical material.

8. The ultra-thin digital imaging device of claim 1, wherein said multi-channel imaging unit comprises a set of microlens arrays that contains a plurality of coaxial lenses, each group of coaxial lenses forming said optical channels.

9. The ultra-thin digital imaging device of claim 8, which comprises a photo camera built into a mobile electronic device.

10. The ultra-thin digital imaging device of claim 9, further comprising a second digital data processor and a display unit connected to said second data processor.

11. The ultra-thin digital imaging device of claim 10, further comprising means for wireless transmission of said data sets from said data storage unit to an external device.

12. The ultra-thin digital imaging device of claim 1, wherein the number of said optical channels is “n”, the number of said microsensors is “m”, and wherein “m” is much greater than “n” and is higher than to 3×10⁶.

13. The ultra-thin digital imaging device of claim 1, which is a self-contained ultra-thin photo camera.

14. The ultra-thin digital imaging device of claim 13, further comprising a second digital data processor and a display unit connected to said second data processor.

15. The ultra-thin digital imaging device of claim 14, wherein said multi-channel imaging unit comprises at least one lens array of identical lenses selected from lenses formed monolithically from a single piece of an optical material and individual lenses assembled into said lens array.

16. The ultra-thin digital imaging device of claim 13, wherein said multi-channel imaging unit comprises a set of microlens arrays that contain a plurality of coaxial lenses, each group of coaxial lenses forming said optical channels.

17. The ultra-thin digital imaging device of claim 1, which has said thickness of less than 50% of said diagonal of said pixilated image-receiving surface.

18. The ultra-thin digital imaging device of claim 11, which has said thickness of less than 50% of said diagonal of said pixilated image-receiving surface.

19. The ultra-thin digital imaging device of claim 13, wherein said self-contained ultra-thin photo camera has a thickness of less than 50% of said diagonal of said pixilated image-receiving surface.

20. A method of forming a high-resolution image of a remote object with the use of an ultra-thin imaging device comprising the steps of:
providing an ultra-thin image-forming device capable of forming a plurality of substantially identical shifted images of said remote object and having a plurality of microsensors;
capturing said remote object by means of said ultra-thin image forming device and forming a plurality of substantially identical shifted images of said remote object;
converting said substantially identical shifted images into electrical signals;
converting said electrical signals into a plurality of substantially identical data sets which correspond to said substantially identical shifted images; and
converting said plurality of identical data sets into a single image of higher resolution by using a known algorithm.

21. The method of claim 20, further comprising a step of storing said plurality of data sets in said data storage means.

22. The method of claim 21, further comprising the step of providing said ultra-thin imaging device with a data memory unit and a digital image display, sending one of said identical shifted images to said data memory unit, and reproducing at least one of said identical shifted images on said digital image display of said ultra-thin imaging device.

23. The method of claim 20, further comprising the step of providing said ultra-thin imaging device with an output port for transmitting said plurality of data sets to an external image-reproducing device.

24. The method of claim 22, further comprising the step of providing said ultra-thin imaging device with an output port for transmitting said plurality of data sets to an external image-reproducing device.

25. The method of claim 20, wherein said ultra-thin imaging device has an image-receiving surface that coincides with said microsensors, said image-receiving surface has a diagonal, said ultra-thin imaging device having a thickness, wherein said thickness is less than 50% of said diagonal.
